(19) United States
(12) Patent Application Publication
(10) Pub. No.: US 2026/0346767 A1
(43) Pub. Date: Nov. 5, 2026

(54) Vehicle Seat Ventilator

(71) Applicant: GENTHERM GMBH, Odelzhausen (DE)

(72) Inventor: Stefan Stöwe, Mering (DE)

(21) Appl. No.: 19/119,853

(22) PCT Filed: Oct. 24, 2023
(86) PCT No.: PCT/DE2023/000134

§ 371 Date: Apr. 10, 2025

(30) Foreign Application Priority Data
Nov. 10, 2022 (DE) 102022004186.3

(51) Int. Cl. B60N 2/56

(52) U.S. Cl. CPC B60N 2/565; B60N 2/5678

(57) ABSTRACT

An air conditioning device for ventilating a vehicle seat, the air conditioning device includes at least one air conveying device configured to convey air through an air-permeable seat cushion of the vehicle seat, at least one electronic air flow monitoring unit configured to detect at least one parameter relating to the conveyed air to determine a humidity of the conveyed air, and an electronic control device arranged on the at least one air conveying device and configured to control the at least one air conveying device depending on the at least one detected parameter, the at least one electronic air flow monitoring unit is part of the electronic control device.

### CROSS REFERENCE TO RELATED APPLICATIONS

This application is a National Stage Entry of PCT/DE2023/000134 filed on Oct. 24, 2023, which claims priority to DE 10 2022 004 186.3 filed on Nov. 10, 2022, the entireties of which are all incorporated by reference herein for all purposes.

### FIELD

The invention relates to an air conditioning device for ventilating a vehicle seat, a vehicle seat, and a method for operating an air conditioning device for a vehicle seat.

### BACKGROUND

Air conditioning devices for vehicle seats are already known from the prior art. For example, publication WO 2019/170622 A1 shows a vehicle seat ventilated by means of a fan, in which sensors are arranged in the seat part and in the backrest of the vehicle seat.

In the known air conditioning devices for vehicle seats, the air flow monitoring units are arranged spatially separated from the air conveying devices and separately beyond the air conveying devices, for example in the seat cushion of the vehicle seat. However, this creates structural and functional problems. Due to the arrangement of the air flow monitoring units beyond the air conveying devices, the air flow monitoring units must be attached separately in the seat cushion and an additional cable connection of the air flow monitoring units with the air conveying devices and with a control device of the air conditioning device is necessary in order to supply the air flow monitoring units with electrical energy and to enable signal transmission. Additional attachments and cable connections are costly and offer additional potential for possible faults and failures of the air conditioning device. In addition, the positioning of the airflow monitoring units in the seat cushion is disadvantageous, as the airflow monitoring units in the seat cushion are exposed to moisture from the sweat of an occupant of the vehicle seat, which can impair the reliable function of the airflow monitoring units and consequently the air conditioning of the vehicle seat. In addition, special measures must be taken when positioning the airflow monitoring units in the seat cushion in order to protect the airflow monitoring units from mechanical damage by the occupant and at the same time not to impair the occupant's seating comfort.

### SUMMARY

The object of the invention thus consists in optimizing the reliability and robustness of air conditioning devices for vehicle seats while reducing the complexity and cost of air conditioning devices.

The object is solved with an air conditioning device of the type mentioned at the outset, wherein the at least one air flow monitoring unit is part of the control device.

The fact that the at least one air flow monitoring unit is part of the control device means that no cable connections are required for signal transmission or for supplying the air flow monitoring unit with electrical energy, thus reducing costs and cabling requirements and shortening signal paths. In addition, both a separate attachment of the air flow monitoring unit beyond the control device and measures to protect the air flow monitoring unit from condensation or mechanical damage can be dispensed with, thus simplifying the air conditioning device and the vehicle seat, saving further costs and ensuring the reliable functioning of the air conditioning device.

Preferably, the air flow monitoring unit is an integral part of the control device. Preferably, at least one seat surface of the vehicle seat or at least one partial region of a seat surface of the vehicle seat is air conditioned and/or ventilated by means of the air conditioning device. The air conveying device is preferably connected to the control device in a signal-conducting and/or electrically conducting manner. The air conveying device is preferably formed as a blower, preferably as an axial fan or radial fan, particularly preferably as a radial fan, wherein the blower preferably comprises a conveying element with a blade wheel and impeller blades. The air conditioning device may comprise multiple air conveying devices. If the air conditioning device comprises multiple air conveying devices, these can, for example, be designed to be more compact than a single air conveying device and/or positioned closer to the seat cushion of the vehicle seat. Multiple air conveying devices are preferably formed as axial fans. Preferably, multiple air conveying devices are networked together in a signal-conducting manner so that, for example, only one of the multiple air conveying devices has an air flow monitoring unit, wherein the sensor signal is transmitted to all other air conveying devices. Preferably, the blower generates a static pressure increase of the air to be conveyed from 50 Pa to 500 Pa. The control device is preferably configured to control the rotational speed of the air conveying device, in particular the rotational speed of the blower, in order to influence the flow speed of an air flow of the conveyed air through the vehicle seat.

Preferably, the air flow monitoring unit is configured to monitor the air to be conveyed continuously or at continuous points in time. The air conditioning device may comprise a housing, wherein the control device is arranged together with the air flow monitoring unit and the air conveying device in the housing. A parameter relating to the conveyed air can be, for example, the flow speed, the relative humidity and/or the temperature of the transported air. The air conditioning device is configured to air condition the body regions of an occupant that are in contact with the ventilated vehicle seat or in the vicinity of the seat (local seat air conditioning). The control device is preferably configured to control the air conveying device autonomously. Preferably, the air conditioning device can be manually activated and/or manually controlled by an occupant, for example by means of a switch or by means of a knob and/or via an electrical display apparatus of the vehicle. Preferably, the air conditioning device is activated automatically. As the air flow monitoring unit is an integral part of the control device, the air flow monitoring unit is arranged in the immediate vicinity of the air conveying device so that the air flow monitoring unit can directly monitor the air conveyed by the air conveying device. The arrangement of the air flow monitoring unit directly on the control device also means that no connecting cables for signal transmission to the control device or supply line for supplying the air flow monitoring unit with electrical energy are required. The air conditioning device is preferably also suitable for ventilating other seating furniture, in particular living room and office furniture.

In a preferred embodiment of the air conditioning apparatus according to the invention, the air flow monitoring unit comprises a humidity sensor or the air flow monitoring unit is formed as a humidity sensor, which is configured to detect the humidity of the air conveyed by means of the air conveying device. The detected humidity can be a relative humidity or an absolute humidity. The control device is preferably configured to control the air conveying device depending on the detected humidity. The humidity of the conveyed air is influenced by the evaporation of the sweat of the occupant and correlates with the heat stress level of the occupant. The humidity detected by the humidity sensor is closely linked to the sweat output of the occupant and consequently to the microclimate between the occupant and the vehicle seat, in particular in the contact regions between the occupant and the vehicle seat. In this way, the controlling depends on the sweat level and thus the stress level of the occupant. To calculate and/or subsequently correct the detected humidity, the air temperature can be detected in addition to the humidity. Preferably, the humidity sensor is formed as a digital humidity sensor. A digital humidity sensor can measure the relative humidity and air temperature and provide these as digital output signals, wherein an absolute humidity (water content of the air in g per kg) can be calculated by means of these two variables. A value for the air quality can also be derived from the humidity.

In another preferred embodiment of the air conditioning apparatus according to the invention, the air flow monitoring unit is part of an electronic circuit board of the control device, wherein the air flow monitoring unit is preferably arranged on the electronic circuit board together with a microcontroller for controlling the air conveying device. Preferably, the microcontroller of the control device is configured to send control signals to the air conveying device for controlling, wherein the microcontroller of the control device is connected to the air conveying device in a signal-conducting manner for this purpose. Preferably, the microcontroller of the control device is configured to receive sensor signals for controlling the air conveying device from the air flow monitoring unit, wherein the microcontroller of the control device is connected to the air flow monitoring unit in a signal-conducting manner for this purpose. The microcontroller is also configured to calculate the control signals based on the sensor data.

The air flow monitoring unit is preferably formed as a surface mount device chip (SMD chip). The air flow monitoring unit is preferably configured to output digital and/or analog control signals. The electronic circuit board is preferably configured to carry the air flow monitoring unit and the microcontroller and to connect them to each other in a signal-conducting manner. The electronic circuit board is preferably formed as a control board. The electronic circuit board is preferably formed as a printed circuit board assembly (PCBA). Thus, by means of electronic communication between the microcontroller, the air flow monitoring unit and the air conveying device, control of the air conditioning device is realized by means of a single control board. Since both the microcontroller for controlling the air conveying device based on the sensor signals and the air flow monitoring unit are arranged together on one circuit board, there is no need for another superordinate control device that processes the control signals or for cable connections between the air flow monitoring unit and the control device for the air conveying device. Preferably, the microcontroller and the air flow monitoring unit are connected to each other via a bus interface, in particular via pulse width modulation (PWM) or via I²C (Inter-Integrated Circuit). Preferably, the circuit board is arranged below a motor stator of the air conveying device.

Preferably, the motor stator of the air conveying device is mechanically connected to the circuit board. Preferably, the circuit board is electrically connected to the stator windings of the air conveying device, for example by connecting pins or by soldering the stator windings to the circuit board. Preferably, the microcontroller executes control software which is configured to receive and/or process sensor signals from the air flow monitoring unit and/or to calculate control signals. Preferably, the control software is configured to calculate a control algorithm for controlling the air conveying device based on the sensor signals and the control signals.

In a further preferred embodiment of the air conditioning apparatus according to the invention, the control device is configured to switch between at least two different operating states of the air conveying device depending on the parameter detected by the air flow monitoring unit. Preferably, the control device is configured to change the operating state of the air conveying device when the parameter relating to the conveyed air falls below or exceeds a defined parameter limit value and/or a defined parameter increase rate.

In a further development of the air conveying apparatus according to the invention, the air conveying device comprises a conveying element, wherein the rotational speed of the conveying element of the air conveying device in a first operating state of the at least two operating states differs from the rotational speed of the conveying element in a second operating state of the at least two operating states. Preferably, the conveying element comprises a blade wheel and one or multiple impeller blades. The rotational speed is preferably a target rotational speed. Preferably, the conveying element of the air conveying device is arranged rotatably on the air conveying device. Preferably, the conveying element is mounted on the air conveying device by means of a plain bearing or a ball bearing.

Furthermore, an air conditioning device according to the invention is preferred, wherein the rotational speed of the conveying element of the air conveying device is higher in the second operating state than in the first operating state, wherein the control device is configured to set the first operating state if the parameter of the conveyed air determined by means of the air flow monitoring unit is below a defined limit value and/or a defined parameter increase rate, and to set the second operating state if the parameter of the conveyed air determined by means of the air flow monitoring unit is above a defined limit value and/or a defined parameter increase rate. Preferably, the control device is configured to switch autonomously between the first and second operating states depending on the at least one parameter. Preferably, the control device is configured to set further operating states in which the rotational speed of the conveying element of the air conveying device differs from the rotational speed in the first and second operating states. The first operating state can be used to convey air to the air flow monitoring unit so that the air flow monitoring unit can determine at least one parameter. Preferably, the air conveying device operates at a low rotational speed so that any air flow generated does not produce any disturbing noise for the occupant. Preferably, the second operating state generates a stronger air flow with a higher air flow speed than the first operating state due to the increased rotational speed. Due to the higher air flow speed in the second operating state, the vehicle seat and thus the occupant are exposed to more air, so that sweat from the occupant evaporates and the occupant is thus cooled. A higher humidity of the transported air may indicate that the occupant is sweating. A sweating occupant may indicate that more air conditioning is needed to cool the occupant and ensure a comfortable microclimate between the occupant and the vehicle seat.

Preferably, the control device is configured to differentiate between sensor signals that are influenced by a sweating occupant and sensor signals that are influenced by external influences, such as high humidity in the outside air that enters the interior through an open window and/or an open vehicle door. With two operating states it is possible to ensure that the air conditioning device only intelligently increases the rotation speed when required and saves energy the rest of the time, thus increasing the energy efficiency of the air conditioning device.

It is also advantageous to have an air conditioning device according to the invention in which the control device is configured to activate the air conveying device when an occupant approaches the vehicle and/or the vehicle is unlocked and/or the vehicle is started and/or the vehicle seat is contacted by an occupant, wherein the control device is preferably configured to initially set the first operating state of the air conveying device after activation. Preferably, the first operating state is a standard operating state, which can be permanently active when the vehicle seat is occupied by an occupant. The first operating state can be activated automatically when an occupant detection device detects an occupant on the vehicle seat. In addition, the first operating state can be activated automatically when an occupant approaches the vehicle, when the vehicle is unlocked or when the vehicle is started. The first operating state is used to initially transport air to the air flow monitoring unit at a low speed of the air conveying device in order to detect the humidity.

In a further preferred embodiment of the air conditioning device according to the invention, the air flow monitoring unit comprises a temperature sensor, which is configured to detect the temperature of the air conveyed by means of the air conveying device, and/or the air flow monitoring unit comprises a VOC sensor, which is configured to detect organic volatile substances in the air conveyed by means of the air conveying device, and/or the air flow monitoring unit comprises a gas sensor, which is configured to detect the gas composition of the air conveyed by means of the air conveying device. A VOC sensor is configured to detect volatile organic compounds (VOC for short) such as hydrocarbons, alcohols, aldehydes and/or organic acids.

In particular, the gas sensor can be configured to detect the CO2 content and/or the methane content and/or the content of sulphur compounds in the conveyed air. Alternatively or additionally, the air flow monitoring unit may comprise a sensor for detecting the flow speed of the conveyed air. Alternatively or additionally, the air flow monitoring unit may comprise a sensor for detecting the density of the conveyed air. Alternatively or additionally, the air flow monitoring unit may comprise a sensor for detecting the air purity and/or the fine dust content of the conveyed air. The air quality of the conveyed air can be derived from all the sensor values detected. Preferably, the control device is configured to control the air conveying device based on the air quality.

In a further development of the air conditioning device according to the invention, the air conveyed by means of the air conveying device passes to the air flow monitoring unit through at least one opening, which extends between a blade wheel and impeller blades of the conveying element of the air conveying device and is preferably formed in the form of a gap for detecting the at least one parameter relating to the air conveyed by means of the air conveying device.

Alternatively or additionally, the air conveyed by means of the air conveying device passes to the air flow monitoring unit through at least one opening in the blade wheel of the air conveying device for detecting the at least one parameter relating to the air conveyed by means of the air conveying device.

Alternatively or additionally, the air conveyed by means of the air conveying device passes to the air flow monitoring unit through at least one air outlet opening of the air conveying device, from which the conveyed air can be conveyed out of the air conveying device, for detecting the at least one parameter relating to the air conveyed by means of the air conveying device.

In order to detect the parameters relating to the conveyed air using the air flow monitoring unit, the conveyed air must pass to the air flow monitoring unit. The air routed to the air flow monitoring unit can also be used to cool the control device. If the conveyed air passes to the air flow monitoring unit through at least one air outlet opening of the air conveying device, the air flow monitoring unit is preferably designed in such a way that the air flow monitoring unit, due to its correct shape and size, is within the range of the air flow through the air outlet opening.

It is also advantageous to have an air conditioning apparatus according to the invention in which the air conveying device comprises a brushless DC motor. A brushless DC motor is characterized in particular by its energy efficiency, its maintenance-free nature and its compact design.

In a further preferred embodiment of the air conditioning apparatus according to the invention, the air conditioning device comprises at least one filter medium which is configured to be flowed through by the air conveyed by means of the air conveying device and to filter the conveyed air. The filter medium can be an activated carbon filter for odor neutralization. The filter medium can also be a particle filter for filtering particles from the air. The air conditioning device may also comprise a UVC lamp to kill germs in the air.

Furthermore, an air conditioning device according to the invention is advantageous, in which the control device and/or the air flow monitoring unit is configured to receive and/or process control signals for controlling the air conveying device from a control apparatus superordinate to the control device and/or to send sensor signals of the air flow monitoring unit and/or control data relating to the air conveying device to the control apparatus superordinate to the control device. The superordinate control apparatus is preferably formed as a so-called master control apparatus and is preferably connected to the air conditioning device via a LIN bus (local interconnect network) in a signal-conducting manner. Preferably, the control device is configured to receive manual user input from an occupant from a superordinate control apparatus, for example manual activation of the air conditioning device and/or manual setting of an operating state. Manual user inputs can be made, for example, via a touch-sensitive display and/or by means of a touch sensor and/or by means of a knob.

Preferably, the control device is configured to send sensor signals of the air flow monitoring unit and/or control data relating to the air conveying device to the control apparatus superordinate to the control device, which sensor signals cause the superordinate control apparatus to activate a seat heating system, for example to dry the occupant more quickly and/or to protect the occupant from hypothermia due to evaporative cooling caused by the evaporation of sweat. In addition, the superordinate control apparatus can be prompted by the sent sensor signals and/or control data to control the entire interior air conditioning of the vehicle depending on the sent sensor signals and/or the sent control data. Sensor signals of the air flow monitoring unit and/or control data relating to the air conveying device sent to the superordinate control apparatus can be, for example, the current operating state of the air conveying device, the air humidity, the air temperature, the air quality, the air gas composition, a seat occupancy state of the vehicle seat and/or possible detected error signals. Control signals received or to be processed by the superordinate control apparatus for controlling the air conveying device can be, for example, control signals for activating the air conveying device from a sleep mode, information relating to the occupant, for example the approach of an occupant to the vehicle or the seat occupancy by an occupant and/or personal preferences of the occupant with regard to the vehicle air conditioning, in particular HMI (human machine interface) inputs.

Preferably, the air flow monitoring unit is configured to start detecting sensor data as soon as an occupant approaches the vehicle and/or as soon as an occupant has opened a vehicle door, even before the occupant sits down on the vehicle seat, so that, for example, high humidity from air entering the vehicle through the vehicle door can be taken into account when detecting the sensor data.

The object of the invention is further solved by a vehicle seat of the type mentioned at the outset, wherein the air conditioning device is formed according to one of the above embodiments. With respect to the advantages and modification of the vehicle seat according to the invention, reference is made to the advantages and modifications of the air conditioning device according to the invention.

In a preferred embodiment of the vehicle seat according to the invention, the air conditioning device is arranged on the bottom face of a vehicle seat bottom part of the vehicle seat or on the back face of a vehicle seat backrest of the vehicle seat or is integrated into an air-permeable seat cushion of the vehicle seat bottom part or the vehicle seat backrest, wherein the air conveying device is preferably configured to draw in the air to be conveyed through the air-permeable seat cushion of the vehicle seat through at least one layer of the seat cushion. Preferably, the air is drawn in through the seat cushion by means of the air conveying device using the air-pull principle. With the air-pull principle, the humid air generated by the sweating occupant is drawn through the seat surface to the air conveying device and thus to the air flow monitoring unit and discharged at the bottom face or back face of the seat cushion.

The air-pull principle has several advantages over an air-push principle, in which the air is not sucked in towards the bottom face and/or back face7, but blown through the seat from the bottom face and/or back face. A vehicle seat that has been exposed to sunlight and has warmed up before the occupant sits down and activates the air conditioning device would cause the air conveyed to the occupant through the seat cushion to heat up, causing uncomfortably warm air to reach the occupant instead of air conditioning the occupant.

In a further preferred form of the vehicle seat according to the invention, the vehicle seat comprises an occupant detection device which is configured to detect an occupancy state of the vehicle seat by an occupant, wherein the air conditioning device is preferably configured to be activated and or controlled depending on the occupancy state of the vehicle seat. The occupant detection device is preferably configured to detect whether the vehicle seat is occupied by an occupant. Preferably, the air conditioning device, in particular an air conveying device of the air conditioning device, is automatically activated as soon as an occupant is detected by the occupant detection device. Preferably, the air conditioning device, in particular an air conveying device of the air conditioning device, is kept active as long as the vehicle seat is occupied by an occupant.

The object of the invention is further solved by a method of the type mentioned at the outset, wherein the at least one air flow monitoring unit is a component of the control device.

In a preferred embodiment of the method according to the invention, an air conditioning device according to one of the preceding embodiments is operated by means of the method. With respect to the advantages and modifications of the method according to the invention, reference is made to the advantages and modifications of the air conditioning device according to the invention.

### BRIEF DESCRIPTION OF THE DRAWINGS

In the following, preferred embodiments of the invention are explained and described in more detail with reference to the accompanying drawings. The Figures show:

FIG. 1 shows a sectional view of an air conditioning device according to the invention from the side;

FIG. 2 shows a schematic side view of a vehicle seat occupied by an occupant with air conditioning devices according to the invention; and

FIG. 3 shows the time curve of a rotational speed of an air conveying device dependent on the time curve of an air humidity signal of an air flow monitoring unit.

### DETAILED DESCRIPTION

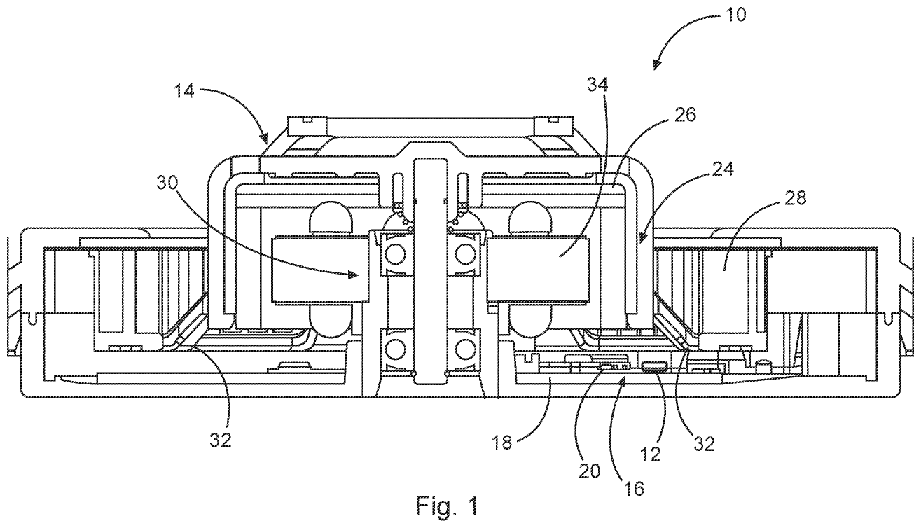

FIG. 1 shows an air conditioning device 10 according to the invention, which comprises an air conveying device 14 and a control device 16. The air conveying device 14 is formed as a radial blower, which draws in air in the axial direction and blows it out in the radial direction. The air conditioning device 10 is configured to ventilate a vehicle seat 100 by conveying air through at least one seat cushion 102 of a vehicle seat 100 by means of the air conveying device 14. The air conveying device 14 comprises a conveying element 24, which has a blade wheel 26 and impeller blades 26. The conveying element 24 is rotatably mounted on a motor stator 31 and is rotated by means of a DC motor 30, so that the impeller blades arranged on the blade wheel 26 of the conveying element 24 perform a rotational movement around the motor stator 34. By the rotational movement of the impeller blades 28, air is set in motion.

The control device 16 comprises a circuit board 18, which is formed as a PCBA (Printed Circuit Board Assembly). A microcontroller 20 and an air flow monitoring unit 14 are arranged on the circuit board 18 of the control device 16. In addition, further electrical components can be arranged on the circuit board 18, for example coils, capacitors and resistors. During operation of the air conditioning device 10, the air flow monitoring unit 14 detects the humidity of the air conveyed by the air conveying device 14. In addition, the air flow monitoring unit can also detect other parameters relating to the conveyed air, such as the air temperature or the gas composition of the air. The microcontroller 20 can receive sensor signals which are based on the parameters, in particular on the humidity of the air, from the air flow monitoring unit 12, process them and derive control signals from the sensor signals. The control signals are used to control the air conveying device 14 depending on the parameters detected. If the sensor signals indicate high humidity or a rapid increase in humidity, this may indicate that an occupant 200 sitting on the vehicle seat 100 is sweating more, so that greater ventilation of the seat is necessary to cool the occupant more. The microcontroller 20 uses the sensor signals of the air flow monitoring unit 12 to calculate whether and to what extent the rotational speed R of the conveying element 24 of the air conveying device 14 needs to be adjusted.

The microcontroller 20 and the air flow monitoring unit 12 are connected to each other in a signal-conducting and electrically conducting manner via the circuit board 18. In this way, sensor signals can be sent from the air flow monitoring unit 12 to the microcontroller 20 and the air flow monitoring unit 12 can be supplied with electrical energy. The arrangement of the air flow monitoring unit 12 directly on the circuit board 18 of the control device 16 enables direct communication via a short signal path without additional cable connections between the air flow monitoring unit 12 and the microcontroller 20. In addition, by arranging the air flow monitoring unit 12 directly on the air conveying device 14, air drawn in by means of the air conveying device 14 can flow directly to the air flow monitoring unit 12 via openings 32 in the region of the impeller blades 28 of the conveying element 24.

The circuit board 18 of the control device 16 is mechanically attached to the motor stator 34 and is connected in a signal-conducting and/or electrically conducting manner to stator windings of the motor stator 34, so that the DC motor 30 can be supplied with electrical energy and controlled by means of the control device 16 in order to adjust the rotational speed R of the conveying element 24 of the air conveying device 14 depending on the parameters of the air detected by the air flow monitoring unit.

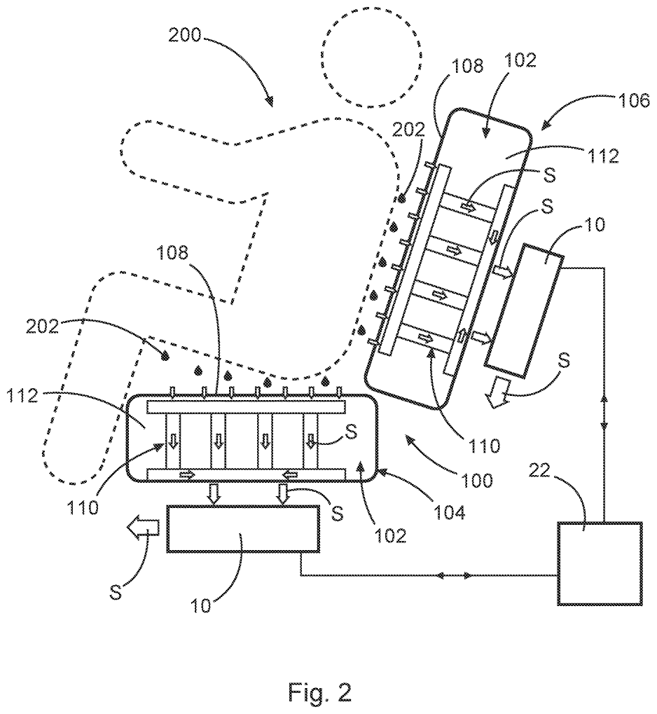

FIG. 2 shows a vehicle seat 100 of a vehicle, wherein an occupant 200 is seated on the vehicle seat 100. The vehicle seat 100 comprises a vehicle seat bottom part 104 and a vehicle seat backrest 106, wherein the occupant 200 contacts the vehicle seat bottom part 104 and the vehicle seat backrest 106 at least in sections.

The vehicle seat 100 comprises two air conditioning devices 10, wherein the vehicle seat bottom part 104 and the vehicle seat backrest 106 are each associated with an air conditioning device 10, which are arranged on the bottom face of the vehicle seat bottom part 104 and on the rear face of the vehicle seat backrest 106. The air conditioning devices 10 draw air through air-permeable seat cushions 102 of the vehicle seat 100, wherein the air flows along a flow path S from an air-permeable surface layer 108 through a fabric layer 110 into the air conditioning devices 10.

The air drawn in by means of the air conditioning devices 10 absorbs moisture in the vicinity of the occupant 200 and in particular in the vicinity of contact regions of the occupant 200 on the vehicle seat 100, which moisture is produced by evaporation of sweat 202 of the occupant 200 in the region of the surface layer 108 of the vehicle seat 100. Because the air flow monitoring unit 12 is arranged directly on the control device 16 in the air conditioning unit 10, the air conveyed by the air conveying device 14 flows at least partially to the air flow monitoring unit 12, so that the humidity of the flowing air can be detected. In addition, the air flow monitoring unit 12 is permanently flooded with air, so that condensation on the air flow monitoring unit 12 and measurement errors resulting therefrom are avoided. In addition, by being arranged on the control device 16 directly on the air conditioning device 10 instead of being arranged within the seat cushion 102, the air flow monitoring unit 12 is protected from mechanical stress by the occupant 200, wherein consequently the seating comfort for the occupant 200 is also increased.

The vehicle seat 100 may be equipped with an occupant detection device so that the air conveying device 14 autonomously starts conveying air in a first operating state B1 at a low rotational speed R as soon as an occupant 200 sits down on the vehicle seat 100, so that air for detecting moisture passes to the air flow monitoring unit. The lower rotational speed R in the first operating state B1 ensures that air constantly passes to the air monitoring unit 12 without burdening the occupant 200 with ventilation noise or avoidable energy consumption. Alternatively or additionally, the air conveying device 14 can start conveying air as soon as the occupant 200 approaches the vehicle from the outside or as soon as the vehicle is unlocked.

If the air flow monitoring unit 12 detects that the humidity of the conveyed air exceeds a defined limit value G1 or that the increase rate of a humidity increase exceeds a limit value, the rotational speed R of the conveying element 24 of the air conveying device 14 is increased by the control device 16 autonomously setting a second operating state B2, so that consequently the flow speed of the conveyed air increases and the vehicle seat 100 with the occupant 200 is ventilated more strongly. As a result of increased ventilation of the occupant 200, more sweat evaporates, which is transported away with the air to dry and cool the occupant 200 and the vehicle seat 200 and improve the microclimate between the occupant 200 and the vehicle seat 100.

In this embodiment example, the air conditioning devices 10 are also connected in a signal-conducting manner to a control apparatus 22 superordinate to the control devices 16 of the air conditioning devices 10. The control apparatus 22 can, for example, be configured to control the air conditioning of the entire vehicle interior. The superordinate control apparatus 22 can receive and process sensor signals from the control devices 16, in particular from the air flow monitoring unit 12, for example to autonomously activate a seat heating system, and/or send control signals to the control devices 10, for example manual inputs of the occupant on an electronic display apparatus of the vehicle.

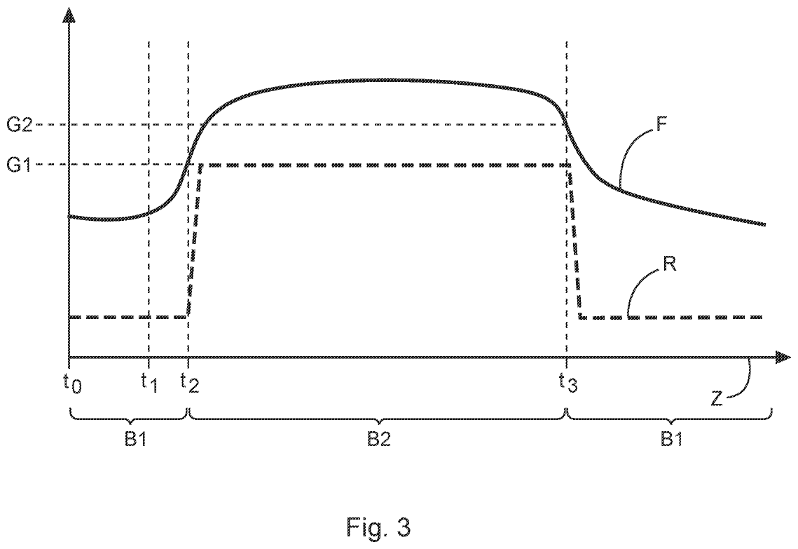

FIG. 3 shows a curve of a rotation speed of the air conveying device 14 depending on an air humidity signal F detected by the air flow monitoring unit 12 over the time Z. At a point in time to, the air conditioning device 10 is activated. The air conditioning device 10 can be activated, for example, as an occupant approaches the vehicle or the vehicle is unlocked at a point in time to. At the point in time to, the first operating state B1 of the air conditioning device 10 is set by means of the control device 16, in which operating state a low rotational speed R of the air conveying device 14 is set in order to convey air to the air flow monitoring unit 12. In addition, the air flow monitoring unit starts to detect the humidity of the conveyed air at the point in time to and outputs a humidity signal F.

At the point in time t1, an occupant 200 sits down on the vehicle seat 100, so that the air conveying device 14 now draws in air containing evaporated sweat from the occupant 200, so that the humidity of the air and correspondingly the humidity signal F of the air flow monitoring unit 12 increases.

At the point in time t2, the humidity and thus the humidity signal F of the air flow monitoring unit reaches a limit value G1. As soon as the limit value G1 is reached, the control device 16 sets a second operating state B2 of the air conditioning device 10, in which the rotation speed R of the air conveying device 14 is increased. By increasing the rotational speed R of the air conveying device 14, the flow speed of the conveyed air is increased, thus intensifying the ventilation of the vehicle seat 100 and thus the air conditioning of the occupant 200 in order to cool and dry the occupant 200. In addition, a signal can be sent to a superordinate control apparatus 22 at the point in time t2, for example to control a seat heating system of the vehicle seat 100 or the interior air conditioning of the vehicle in order to support the drying and air conditioning of the occupant 200 and to avoid hypothermia of the occupant 200.

At the point in time t3, the humidity of the conveyed air and thus the humidity signal F of the air flow monitoring unit 12 falls below a limit value G2. For example, the humidity of the conveyed air may decrease when the occupant 200 has been successfully dried and the occupant 200 sweats less or when the occupant 200 leaves the vehicle seat 100. If the air flow monitoring unit 12 signals that the limit value G2 is undershot, the control device sets the first operating state B1 with the lower rotational speed R of the air conveying device 14, since air conditioning of the occupant 200 is no longer necessary and the lower rotational speed R in the first operating state B1 reduces the energy consumption and the volume of the air conveying device 14, wherein air continues to be conveyed to the air flow monitoring unit 12 in order to examine the air for a renewed increase in humidity.

### REFERENCE NUMBERS

10 Air conditioning device
12 Air flow monitoring unit
14 Air conveying device
16 Control device
18 Circuit board
20 Microcontroller
22 Control unit
24 Conveying element
26 Blade wheel
28 Impeller blades
30 Direct current motor
32 Openings
34 Motor stator
100 Vehicle seat
102 Seat cushion
104 Vehicle seat bottom part
106 Vehicle seat backrest
108 Surface layer
110 Fabric layer
112 Cushion foam layer
200 Occupant
202 Sweat
B1, B2 Operational state
F Humidity signal
G1, G2 Limit value
R Rotational speed
S Flow path
to-t3 Points in time
Z Time

1. An air conditioning device for ventilating a vehicle seat comprising;
at least one air conveying device that is configured to convey air through an air-permeable seat cushion of the vehicle seat,
at least one electronic air flow monitoring unit that is configured to detect at least one parameter relating to the conveyed air to determine a humidity of the conveyed air, and
an electronic control device that is arranged on the at least one air conveying device and is configured to control the at least one air conveying device depending on the at least one detected parameter,
wherein the at least one electronic air flow monitoring unit is part of the electronic control device.

2. The air conditioning device according to claim 1, wherein the at least one electronic air flow monitoring unit comprises a humidity sensor or is formed as a humidity sensor that is configured to detect the humidity of the conveyed air conveyed by means of the at least one air conveying device.

3. The air conditioning device according to claim 1, wherein the at least one electronic air flow monitoring unit is part of an electronic circuit board of the electronic control device, wherein the at least one electronic air flow monitoring unit is preferably arranged on the electronic circuit board together with a microcontroller for controlling the at least one air conveying device.

4. The air conditioning device according to claim 1, wherein the electronic control device is configured to switch between at least two different operating states of the at least one air conveying device depending on the at least one parameter detected by the at least one electronic air flow monitoring unit.

5. The air conditioning device according to claim 4, wherein the at least one air conveying device comprises a conveying element, wherein a rotational speed of the conveying element in a first operating state of the at least two different operating states differs from a rotational speed of the conveying element in a second operating state of the at least two different operating states.

6. The air conditioning device according to claim 5, wherein the rotational speed of the conveying element the is higher in the second operating state than in the first operating state, wherein the electronic control device is configured
i) to set the first operating state if the at least one parameter of the conveyed air determined by the at least one electronic air flow monitoring unit is below a defined limit value and/or a defined parameter increase rate, and
ii) up to set the second operating state if the at least one parameter of the conveyed air determined by the at least one electronic air flow monitoring unit is above the defined limit value and/or the defined parameter increase rate.

7. The air conditioning device according to claim 4, wherein
the electronic control device is configured to activate the at least one air conveying device when:
i) an occupant approaches the vehicle, and/or
ii) the vehicle is unlocked, and/or
iii) the vehicle is started, and/or
iv) the vehicle seat is contacted by an occupant, wherein the electronic control device is configured to initially set the first operating state of the at least one air conveying device after activation.

8. The air conditioning device according to claim 1, wherein
the at least one electronic air flow monitoring unit comprises one, multiple, or all of the following sensors:
i) a temperature sensor, which is configured to detect the temperature of the conveyed air by the at least one air conveying device,
ii) a VOC sensor, which is configured to detect organic volatile substances in the conveyed air by: of the at least one air conveying device,
iii) a gas sensor, which is configured to detect a gas composition of the conveyed air by the at least one air conveying device.

9. The air conditioning device according to claim 1, wherein the conveyed air by the at least one air conveying device passes to the at least one electronic air flow monitoring unit through:
i) at least one opening, which extends between a blade wheel and impeller blades of a conveying element of the at least one air conveying device and is formed in a form of a gap, and/or
ii) at least one opening in the blade wheel (26) of the at least one air conveying device and/or
iii) at least one air outlet opening of the at least one air conveying device, from which the conveyed air can be conveyed out of the at least one air conveying device,
for detecting the at least one parameter relating to the conveyed air by the at least one air conveying device.

10. The air conditioning device according to claim 1, wherein, the at least one air conveying device comprises a brushless DC motor.

11. The air conditioning device according to claim 1, wherein the air conditioning device comprises at least one filter medium that is configured to be flowed through by the conveyed air by the at least one air conveying device and to filter the conveyed air.

12. The air conditioning device according to claim 1, wherein, the electronic control device and/or the at least one electronic air flow monitoring unit is configured to:
i) receive and/or process control signals for controlling the at least one air conveying device from a control apparatus superordinate to the electronic control device, and/or
ii) send sensor signals of the at least one electronic air flow monitoring unit and/or control data relating to the at least one air conveying device to the control apparatus superordinate to the electronic control device.

13. A vehicle seat, with the air conditioning device according to claim 1.

14. The vehicle seat according to claim 13, wherein the air conditioning device is arranged on a bottom face of a vehicle seat bottom part of the vehicle seat, or on a back face of a vehicle seat backrest of the vehicle seat, or is integrated into an air-permeable seat cushion of the vehicle seat bottom part or the vehicle seat backrest, wherein the at least one air conveying device is configured to draw in the air to be conveyed through the air-permeable seat cushion of the vehicle seat through at least one layer of the seat cushion.

15. The vehicle seat according to claim 13, wherein the vehicle seat comprises an occupant detection device which that is configured to detect an occupancy state of the vehicle seat by an occupant, wherein the air conditioning device is configured to be activated and/or controlled depending on the occupancy state of the vehicle seat.

16. A method for operating air conditioning device according to claim 1, comprising the steps of:
conveying the air through the air-permeable seat cushion of the vehicle seat by the at least one air conveying device,
detecting the at least one parameter relating to the conveyed air by the at least one air conveying device with the at least one electronic air flow monitoring unit, wherein the humidity of the conveyed air can be determined by the at least one detected parameter, and
controlling the at least one air conveying device depending on the at least one detected parameter by the electrical control device, which is arranged on the at least one air conveying device,
wherein the at least one electronic air flow monitoring unit is part of the electronic control device.
